(19) United States
(12) Patent Application Publication
(10) Pub. No.: US 2012/0036925 A1
(43) Pub. Date: Feb. 16, 2012

(54) Digital Flow Meter with Enhanced Turndown Ratio

(75) Inventor: Robert S. Keys, Viola, WI (US)

(73) Assignee: SENTRY EQUIPMENT CORPORATION, Oconomowoc, WI (US)

(21) Appl. No.: 13/206,250

(22) Filed: Aug. 9, 2011

Related U.S. Application Data
(60) Provisional application No. 61/372,343, filed on Aug. 10, 2010.

(51) Int. Cl. G01F 1/69

(52) U.S. Cl. 73/204.25

(57) ABSTRACT

A digital fluid flow meter for measuring fluid flow past a surface on one side of a wall including first and second reduced thickness areas in the wall spaced from one another, a first detector having a first temperature sensitive element thermally coupled to the first reduced thickness area to provide thermal transfer between fluid in contact with the surface and the first detector, a second detector comprising a second temperature sensitive clement thermally coupled to the second reduced thickness area of said wall to provide thermal transfer between fluid in contact with the surface and the second detector. The digital fluid flow meter includes means for sensing the temperature of the first and second temperature sensitive elements, first and second heating elements for heating the respective temperature sensitive elements proximate to the first and second detectors, respectively. The meter includes means for providing input power and control signals to the first and second heating elements and means for transmitting output signals from the temperature sensing means. The wall may be a tube having reduced diameter sections for improving the turndown ratio, total turndown and sensitivity of the digital fluid flow meter.

### FIELD OF THE INVENTION

This invention is related generally to flow meter technology. More particularly, the invention relates to the field of digital flow meters and systems for use in environments in which it is desired to measure flow rates and temperatures over a wide range without invading or affecting the flow of the fluid which is to be measured.

### BACKGROUND OF THE INVENTION

Flow meters which operate according to a calorimetric principle are used in industrial applications. The calorimetric principle involves heating a heat sensitive element, such as a thermistor or resistance temperature device or detector, which is a temperature dependent element or resistor during exposure to the flow of the fluid to be monitored. The flow cools the heat sensitive element resulting in a resistance change as a function of the velocity of the flow. This resistance change can be evaluated to determine the flow rate. Since the temperature change of the heat sensitive element may be the result of changes in the temperature of the medium as well as the flow, special measures must be taken to compensate for or eliminate the influence of changes in the temperature of the medium. The present invention relates to an improved method and apparatus for measuring flow using calorimetric principles and providing improved turndown ratios and high turndown values by varying the inner diameter of the assembly in which fluid flow is measure.

One of the primary disadvantages with calorimetric flow meters presently available is the low turndown ratio achieved and low turndown values provided, by such meters. The digital flow meter of the present invention overcomes this disadvantage by providing a meter having turndown ratios is excess of 100 to 1, and preferably in excess of 1000 to 1, and more preferably in excess of 2400 to 1, increasing the ability and accuracy of fluid measurement in low flow situations.

In addition, existing meters are limited to use with, and calibration in conjunction with, a known fluid. Field conditions often involve mixtures with gases being dissolved therein at different levels. By monitoring the amount of time it takes the fluid to increase in temperature when flow stops and communicating such information digitally to a controller, the data from the meter can be field calibrated for fluids that change due to external dynamics. (As an example only, Thiol mixtures used for odorizing natural gas being used as a driver). As used herein, fluid means a substance that continually deforms or flows under an applied shear stress. Fluids may include liquids, gases, plasmas, slurries, admixtures, liquid carriers and the like, or any combination thereof

### OBJECTS OF THE INVENTION

It is an object of the present invention to provide a digital flow meter capable of achieving turndown ratios is excess of 100 to 1 and in excess of 1000 to 1 and as high as in excess of 2400 to 1 to provide accurate flow rate detection in extremely low fluid flow environments.

Another object of the present invention is to provide a digital flow meter with is capable of calibration in field environments with unknown fluids to achieve accurate flow measurements.

Yet another object of the present invention is to provide a digital flow meter which monitors the time it takes the fluid to increase in temperature when flow stops and communicating such information digitally to a controller. A further object of the present invention is to provide a digital flow meter which can provide data which allows the meter to be field calibrated for fluids that change due to external dynamics. Yet a further object of the present invention is to provide a digital flow meter with a measuring tube providing multiple temperature measurements for increasing the accuracy of measuring the fluid flow rate through a wide range of fluid rates.

Another object of the present invention is to provide a digital flow meter with a measuring sections or machined assemblies having varying inner diameters (ID) over a length to increase the accuracy and sensitivity of the measurement of the fluid flow.

These and other objects of the invention will be apparent from the following descriptions and from the drawings.

### SUMMARY OF THE INVENTION

Accordingly, the present invention provides a digital flow meter for measuring the flow of a medium including but not limited to a slurry, liquid, plasma, admixture, gas or other fluid using a flow sensor comprising a first resistance temperature device or “RTD” as a temperature sensor arranged along a sampling length through which the fluid flows. The flow sensor also includes a heating device or circuit for periodically heating a second RID to a first temperature. Once heated through controlled pulsing of a power source, the second RTD is then allowed to cool and its resistance changes as a function of the flowing fluid. The changing resistance is reflected in an output signal from the second RTD. A bridge circuit is connected with the second RTD to maintain a constant voltage as the temperature of the fluid changes, thereby to compensate for fluctuations in the temperature of the fluid, whereby the output signal is solely a function of the flow of the fluid. The bridge circuit may include a micro-controller, microprocessor, or a similar digital circuit which accepts inputs, including pulses and temperatures, which can be linearized by the circuit to determine or otherwise obtain the flow rate of the fluid.

According to a further object of the invention, the heating device preferably comprises a resistance element arranged in spaced relation from the second RTD and a pulse generator connected with the resistance element for periodically energizing the resistance element to heat the second RTD to the first temperature.

The control device may comprise a transistor, a current or voltage source, an operational amplifier, a micro-controller, a microprocessor or similar integrated or digital circuit. The term “temperature sensitive element” as used herein may include resistance temperature devices, resistance temperature detectors, thermistors, thermocouples temperature sensitive diodes, heatable temperature detectors, other transistors or solid state devices and the like.

### BRIEF DESCRIPTION OF THE DRAWINGS

In order that the advantages of the invention will be readily understood, a more detailed description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view of an embodiment of the inventive digital flow meter with enhanced turndown ratio;

FIG. 1A is a top view of the embodiment of FIG. 1;

FIG. 2 is a perspective view of the flow tube used for fluid flow measurement in the digital fluid flow meter of the present invention;

FIG. 3 is a top view of the flow tube of FIG. 2;

FIG. 4 is a side view of the flow tube of FIG. 2;

FIG. 5 is a cross-section view of the flow tube of FIG. 2 taken along lines 5-5 of FIG. 4;

FIG. 6 is a cross-section view of the flow tube of FIG. 2 taken along lines 6-6 of FIG. 4;

FIG. 7 is a cross-section view of the flow tube of FIG. 2 taken along lines 7-7 of FIG. 4;

FIGS. 8A and 8B together are a circuit schematic showing two flow sensors used to measure fluid flow in the digital fluid flow meter of the present invention;

FIG. 8C is a circuit schematic showing an alternative embodiment of an RTD header;

FIG. 9 is a circuit schematic of the analog to digital converter which converts the temperature outputs of the flow sensors shown in FIGS. 8A and 8B;

FIG. 10 is a circuit schematic showing a circuit for voltage regulation to produce the 3.3V DC from the incoming 24V DC power source

FIGS. 11A, 11B and 11C together are a circuit schematic showing the micro-controller to linearize and provide the output of the measure of fluid flow in the digital fluid flow meter of the present invention;

FIG. 12 is pulse diagram of a no load wave form applied to the circuit of FIGS. 8-11; and

FIG. 13 is pulse diagram of a load wave form applied to the circuit of FIGS. 8-11.

### DETAILED DESCRIPTION OF PREFERRED EMBODIMENTS

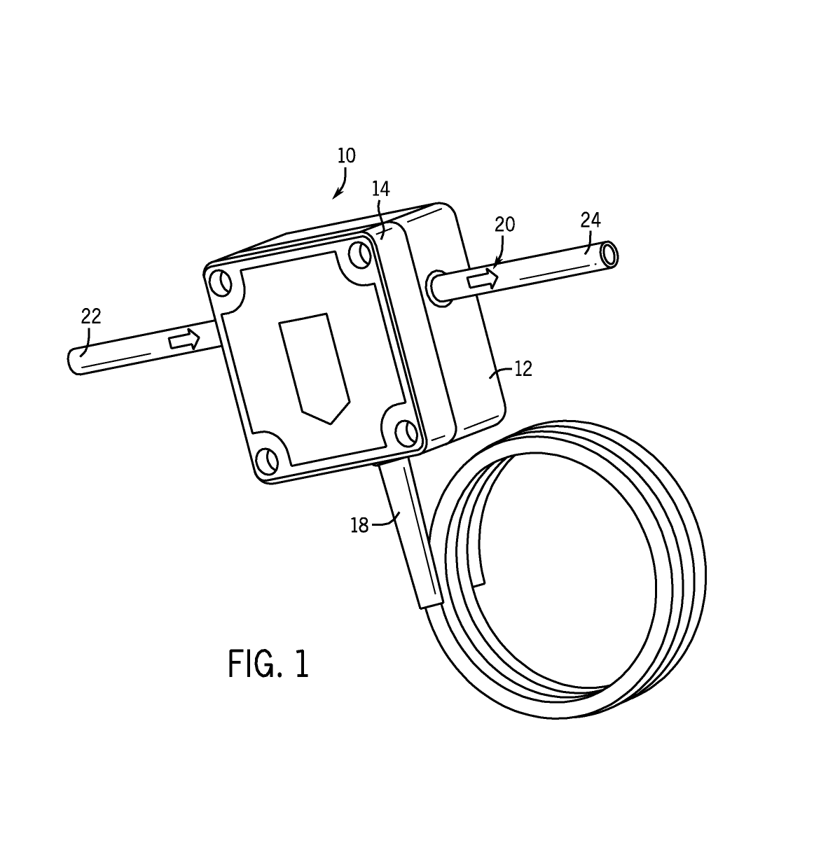

A preferred embodiment of the digital flow meter of the present invention is shown in FIGS. 1 and 1A. As illustrated, a digital flow meter 10 with enhanced turndown ratio includes housing 12 with top 14 encasing the electronic circuitry. Top 14 is secured to housing 12 through fasteners 16. Fasteners 16 may include rivets, screws, bolts or the like. Power is provided to the digital flow meter through input cord 18. A preferred embodiment of flow meter 10 includes measuring tube 20 having an input end 22 and an output end 24. The measurement described below is taken between ends 22, 24 in measurement section 26 of measuring tube 20. Fluid flows in the direction from the input end 22 to the output end 24 as shown by the arrows in FIGS. 1 and 1A. It may be appreciated by those skilled in the art that measuring tube 20 may include one or more machined assemblies. Such assemblies may include solid bar stock which is machined with varying inner diameters, varying diameters of bar stock machined with varying inner diameters connected as required, multiple tubes welded together, a manufactured manifold with multiple tubes and the like.

Flow meter 10 includes one or more flow sensors. Each flow sensor includes one reference resistance temperature device or detector (RTD) and one resistance temperature device or detector (RTD) dissipating heat into the fluid being measured. The flow sensors (not shown) are positioned on measuring tube 20 at various predetermined positions between input end 22 and output end 24. It will be appreciated by those skilled in the art that placement of the various RTD members is important to obtain the proper and most accurate measurements. Hence it is preferable for the various RTD members forming the flow sensor to be placed the same distance apart with each flow sensor. In addition, it is preferable to keep the RID members as close to parallel as possible with respect to each flow sensor. It is also preferable to keep the RTD members as close to parallel as possible from one flow sensor to the next.

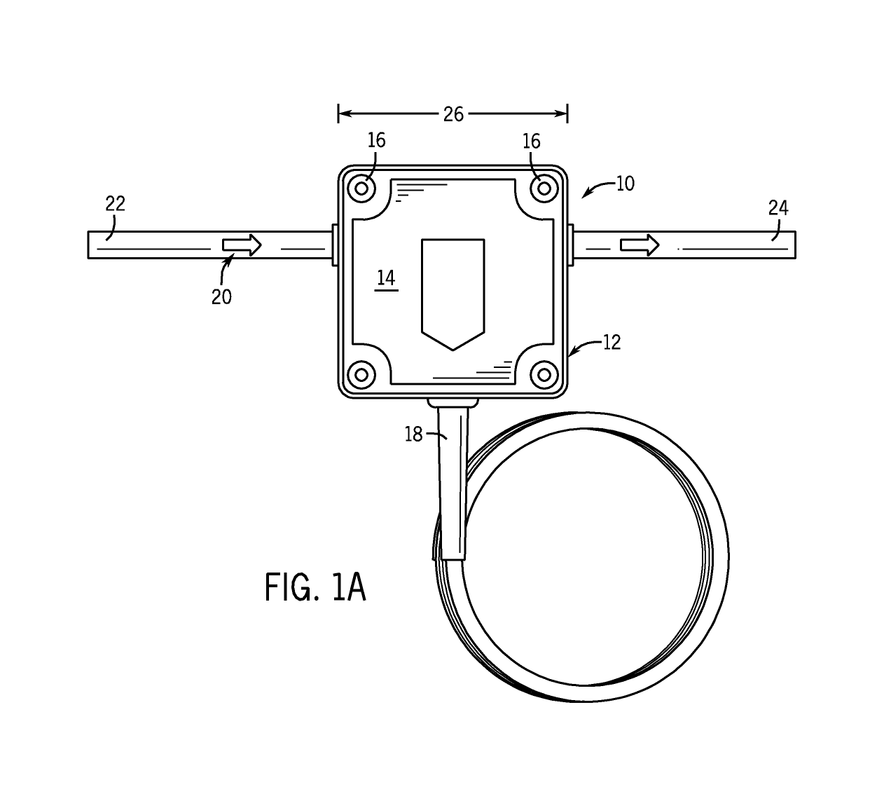

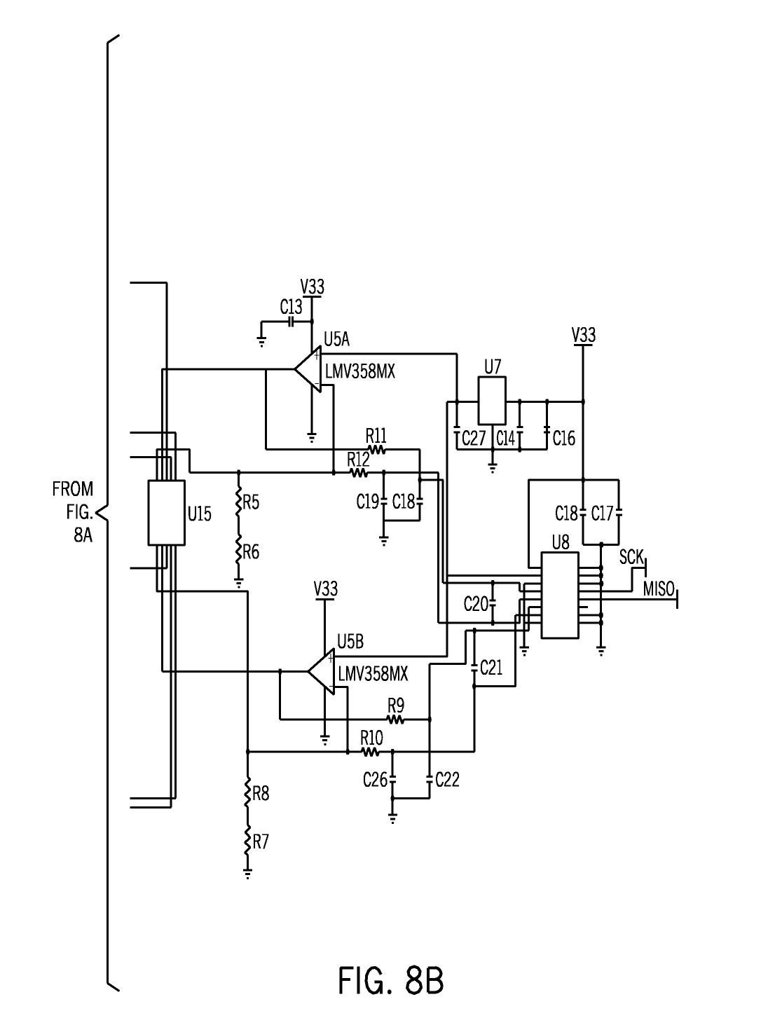

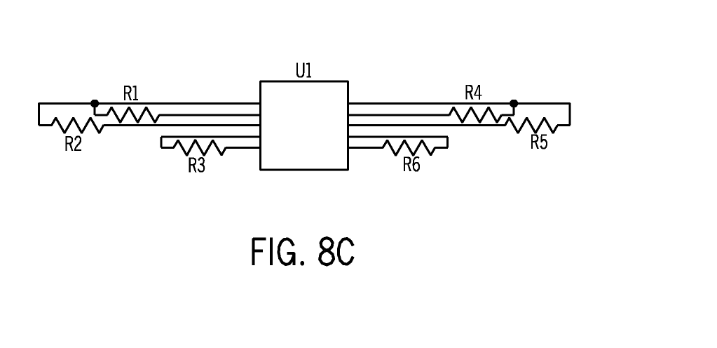

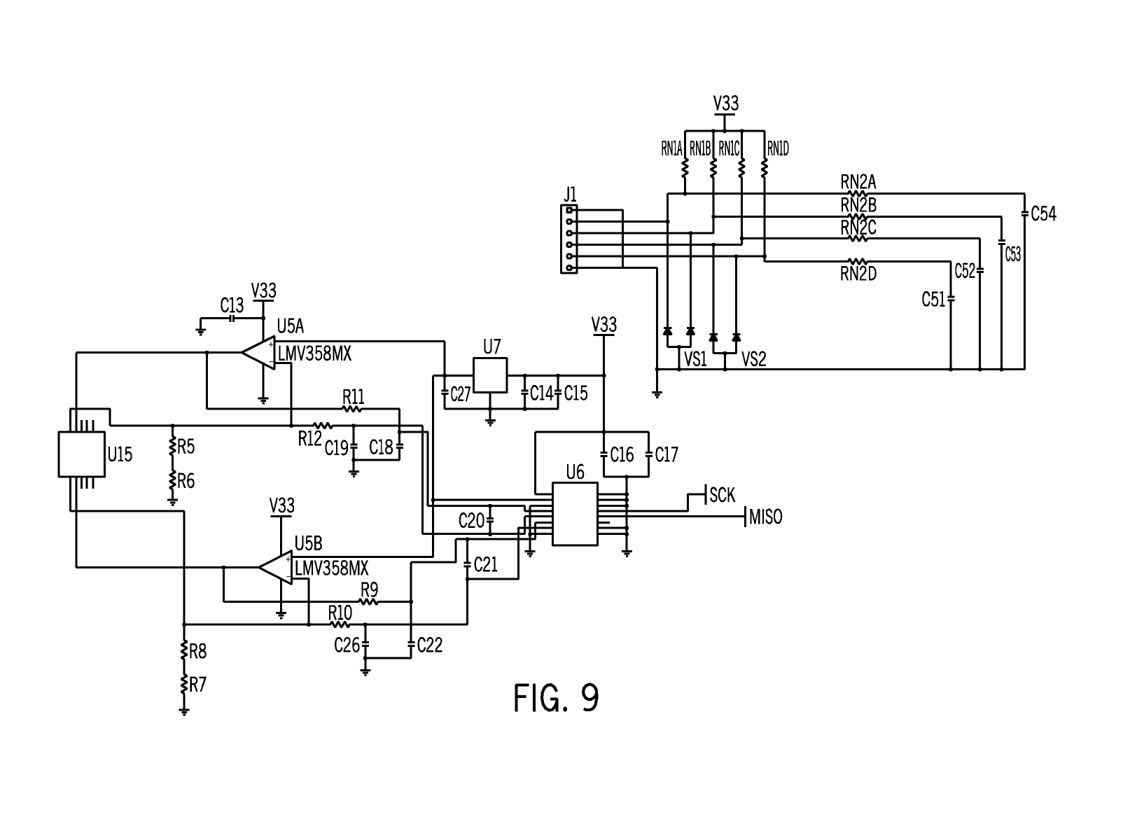

Referring to FIGS. 2-7, measuring tube 20, having input end 22, output end 24 and measurement section 26, is shown in detail. As can be seen, within measurement section 26, there are formed three reduced thickness areas 28A, 28B and 28C. Each of these reduced thickness areas preferably forms a flat surface on which one of the flow sensors is placed. It is preferred that the RTD members be positioned as close as possible to one another, and preferably no more than 0.05″ apart. This positioning provides the most accurate measurements and prevents temperature variations from affecting the measurements. It is preferred that the reduced thickness areas (28A, 28B and 28C) be thermally isolated from each other to further improve the accuracy of the temperature measurements and the accuracy of the measurement of the flow rate of the fluid.

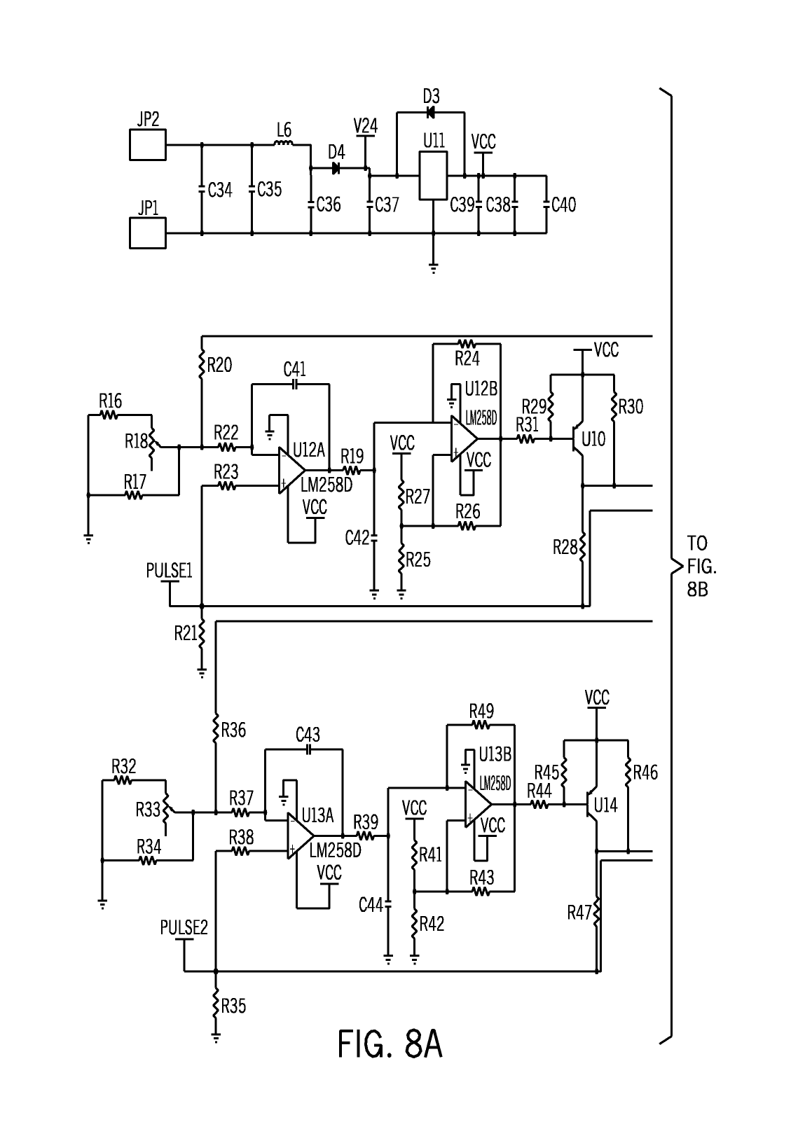

As can be seen in FIG. 4, each reduced thickness area is formed such that the distance from the wall of the inner diameter of the tube is constant. Such distance between the top of the reduced thickness area to the inner diameter wall of tube 20 is preferably 0.164″. It may be appreciated that distance from the top of the area of reduced thickness to the inner diameter of tube 20 may vary depending on pressure requirements, operating environments and the like. Accordingly, a preferred range may be from approximately 0.05 to approximately 0.25 for fluid flow rates from about 0.05 ml/min to about 120 ml/min. It is desired that this distance be chosen to reduce the response time of the measuring sensor and to reduce any error which may be introduced by the ambient temperature within the measuring areas. Such positioning of the flat surface is required to provide consistency in measuring depth from the RID to the fluid flow within tube 20.

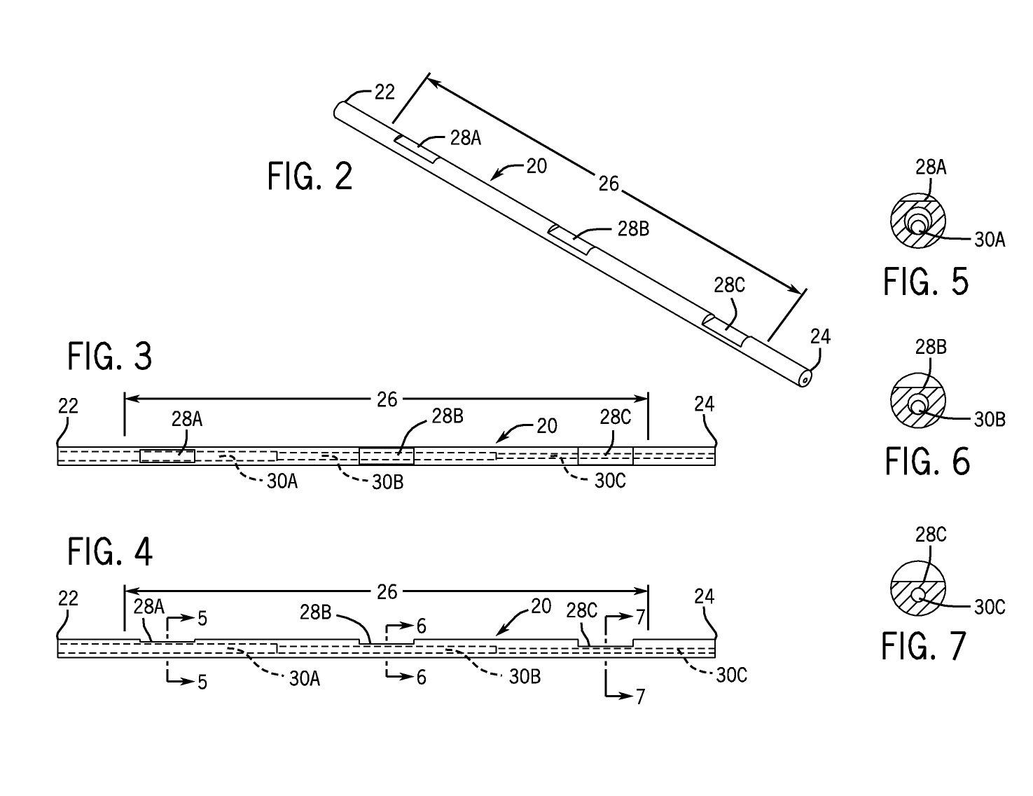

As illustrated in FIGS. 3-7, to provide the improve the sensitivity of the digital flow meter, a reduction in the diameter of the measuring tube 20 is preferable. Such diameter reduction can be in multiple sections as required by the application. As illustrated in FIGS. 3 and 4, three sections are shown, specifically 30A, 30B and 30C. Each section may be from approximately 1″ to approximately 3″ in length and preferably from approximately 1″ to approximately 2″ in length. It is preferred that each section have at least 10 inner diameter measurements in length before the flat begins (28A, 28B and 28C) and 5 inner diameter measurements in length after the flat (28A, 28B and 28C) ends. This assures the most constant possible flow profile and provides the greatest accuracy in the measurements being obtained by the digital flow meter. It will be appreciated by those skilled in the art that the number of flats included on tube 20 may be at least 2, more preferably 3, but can be up to N as required by the type of fluid and the type of fluid flow to be measured. Increasing the number of flats or reduced thickness areas increases the sensitivity of the fluid low meter. Such increase may also increase the turndown ratio or rangeability of the fluid flow meter.

The machining assemblies, of which measuring tube 20 is one preferred variation, may be constructed of any type of compatible material as necessary for the particular application. Preferably, the machining assemblies form at least two (2) inner diameters that are progressively smaller as required by the particular application. Such may be formed by drilling, various machining operations, construction using various preformed materials and similar methods of construction, machining, forming or the like. Multiple inner diameters are formed, and may be preferably offset drilled, so that they become smaller in the direction of fluid flow and may be from 2, 3, 4 N in number where ID₁>ID₂>ID₃>ID_{N}. Providing multiple inner diameters that are reduced, multiplies the effective turndown ratio allowing measurement of fluid flow rates as low as approximately 0.1 ml/min to approximately 0.05 ml/min.

The turndown ratio of a meter may be defined as a flow measurement term that indicates the range a specific flow meter, or meter type, is able to measure with acceptable accuracy. It is also known as rangeability. Rangeability may be considered the ratio of the maximum flow to the minimum flow of a meter. Measurement of different types of fluids may require more sensitive meters to produce accurate flow measurements. The more sensitive the meter needs to be to accurately measure low rate fluid flow, the higher the turndown ratio needs to be. It is important to obtain a high turndown ratio to match the flow meter capabilities in low flow rate applications.

As an example, reducing the ID of measurement tube 20 by a factor of 10 times from the first section to the second section and by another factor of 10 times from the second section to the third section provides the following turndown ratios:

Turndown at flat 1=10(10 ml/min-100 ml/min)
Turndown at flat 1=10(1 ml/min-10 ml/min)
Turndown at flat 1=10(0.1 ml/min-1 ml/min)
Total turndown=10×10×10=1000

Inner diameters of approximately 1/16″ (0.0625″) to approximately ¼″ (0.25″) may be used based on the application required. More preferably, inner diameters of approximately 1/16″ (0.0625″) to approximately ⅛″ (0.125″) may be used.

The machined assemblies used for measuring herein, which as described above include measuring tube 20, may be constructed from stainless steel bar stock which is machined, formed constructed or otherwise prepared as required to form the necessary inner diameter for each required application. Such bar stock may be drilled as necessary or otherwise formed with the required inner diameter to provide the measuring locations as necessary. In other applications, copper or iron may be preferred, but any type of compatible material may be used. It may also be contemplated to coat the inner surface of the machined assemblies to achieve performance is specialty applications. Any type of coating necessary to improve measurement characteristics or performance is contemplated herein.

The digital flow meter of the present invention may be used in a variety of applications in which it is desired to accurately measure the flow rate of a fluid, known or unknown, behind a wall or within a tube. Such applications may include but are not limited to flow of natural gas, steam, water, petroleum any type of liquid, slurry, admixture or the like. Accurate measurements are obtained with fluid flow rates from approximately 0.05 ml/min to approximately 120 ml/min. Such flow rate ranges in conjunction with ID reductions for typical applications may provide turndown ratios in excess of 2400 to 1 or in excess of a total turndown of 2400.

It will be appreciated that the sensors may be placed directly in the stream of the fluid for taking their measurements. However, it is preferred that the sensors take their measurements in a non-invasive manner such that they are positioned proximate to but not within the flow stream of the fluid. The pulsed signal from the flow sensors are provided to and read by the micro-controller. Linearization and temperature compensation are performed by the micro-controller. The micro-controller includes a modulated bus output (a proprietary bus provided by Sentry Equipment Corporation of Oconomowoc, Wisconsin under the trademark MODBUS®) for sending data to one or more of a plurality of devices including a Distributed Control System (DCS), a Lab station, an analyzer, an analyzing station or the like. It may be appreciated that the digital flow meter of the present invention may have a variety of options, including but not limited to one or more displays, one or more keypads, one or more keyboards, and other input/output devices.

In operation, fluid passes through the tube and pulse values are read, linearized, temperature compensated and either displayed, located or stored in a register to be read by and through the MODBUS® output. Fluid temperature may also be displayed or read through the MODBUS® output.

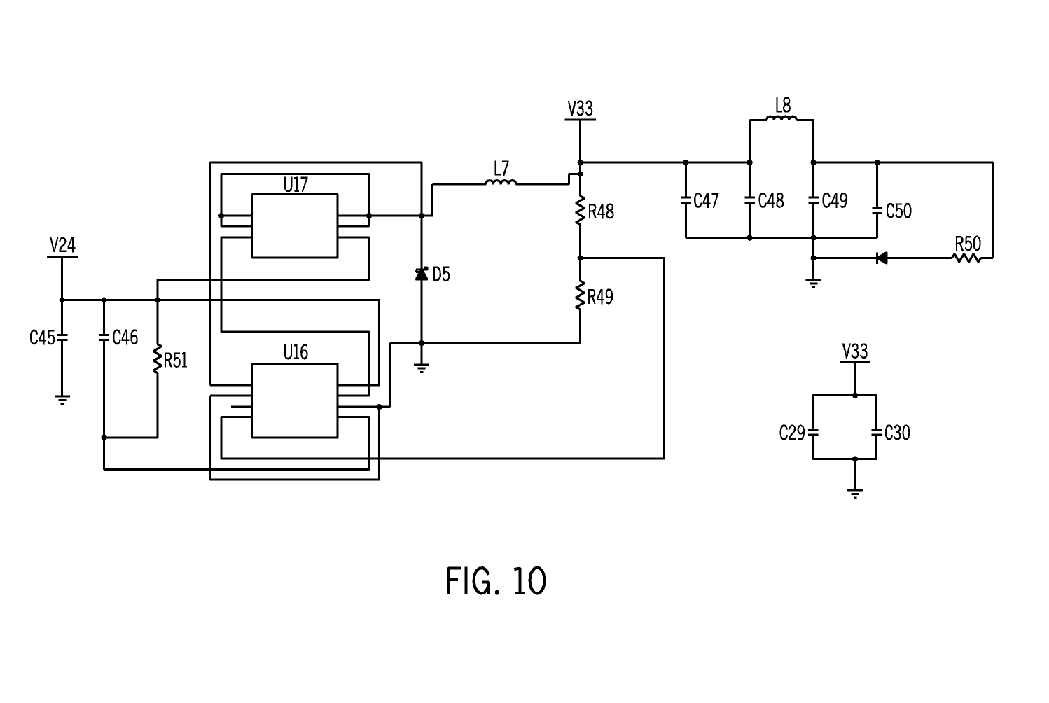

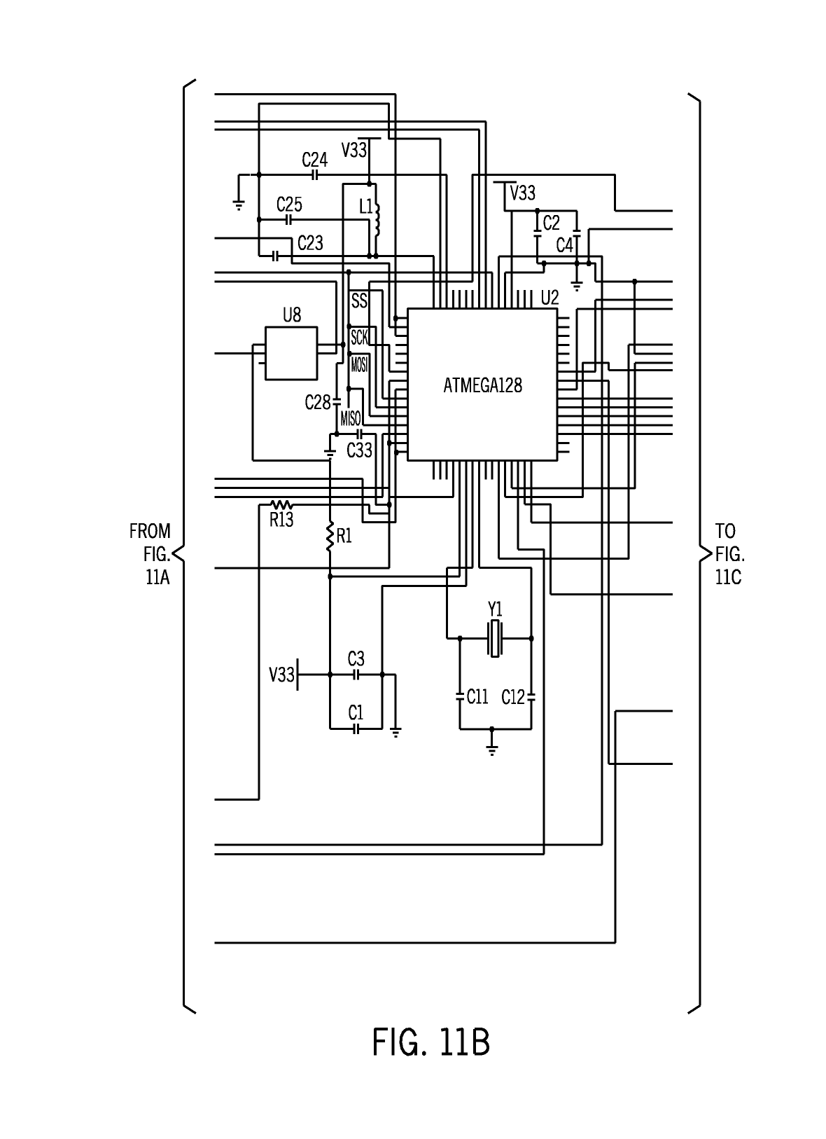

Now turning to the construction and operation of the preferred embodiment of the circuit, reference is made to FIGS. 8-11. As can be seen in FIGS. 8A, 8B and 8C, an ambient sensor controls a “reference” voltage applied to the “−” input of USA. The RTD header is designated as U15 in FIG. 8B and U1 in FIG. 8C. FIG. 8B shows one preferred embodiment of the RTD header while a second preferred embodiment is shown in FIG. 8C.

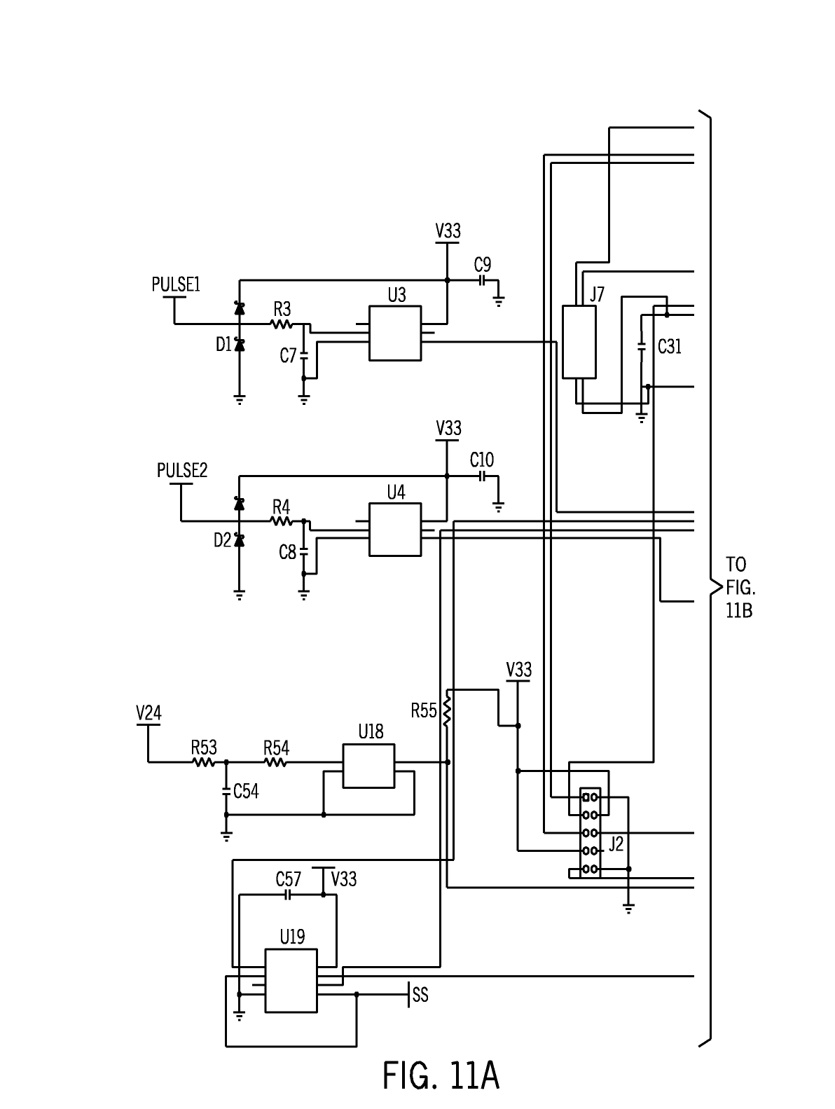

As shown in FIGS. 8A, 8B and 9, the “+” input to U12A is “feedback” from the driven sensor. Resistors R16, R17 and R18 and R20 are used for a reference voltage at the op-amp U12A, U12B for detection of ambient temperature. The error between the reference voltage and the feedback voltage is integrated by U12A through resistor R22. The “gain” of the integrator is proportional to C41 (the integrating capacitor shown in FIG. 8A) and inversely proportional to R22 (shown in FIG. 8A). In FIG. 8, resistor R23 balances the input bias current on the other input. Such circuit configuration prevents the input bias current applied to the op-amp from affecting the circuit performance and ultimate readings provided thereby.

Resistors R24, R19 (shown in FIG. 8A) and capacitor C42 (shown in FIG. 8A) form an oscillator at U12B. The duty cycle of the oscillator will vary as the output of U12A varies. Resistors R27 and R25 (shown in FIG. 8A) form a threshold around which the oscillations occur and resistor R26 provides hysteresis, to make sure the intended oscillation occurs. U10 (shown in FIG. 8A) is the power driver for both resistance temperature devices or detectors (RTDs). The output of the driven RTD is pulsed by the drive circuit, so the reference sensor must also be pulsed. This pulsing is necessary so the error signal does not depend on the duty cycle of the drive circuit.

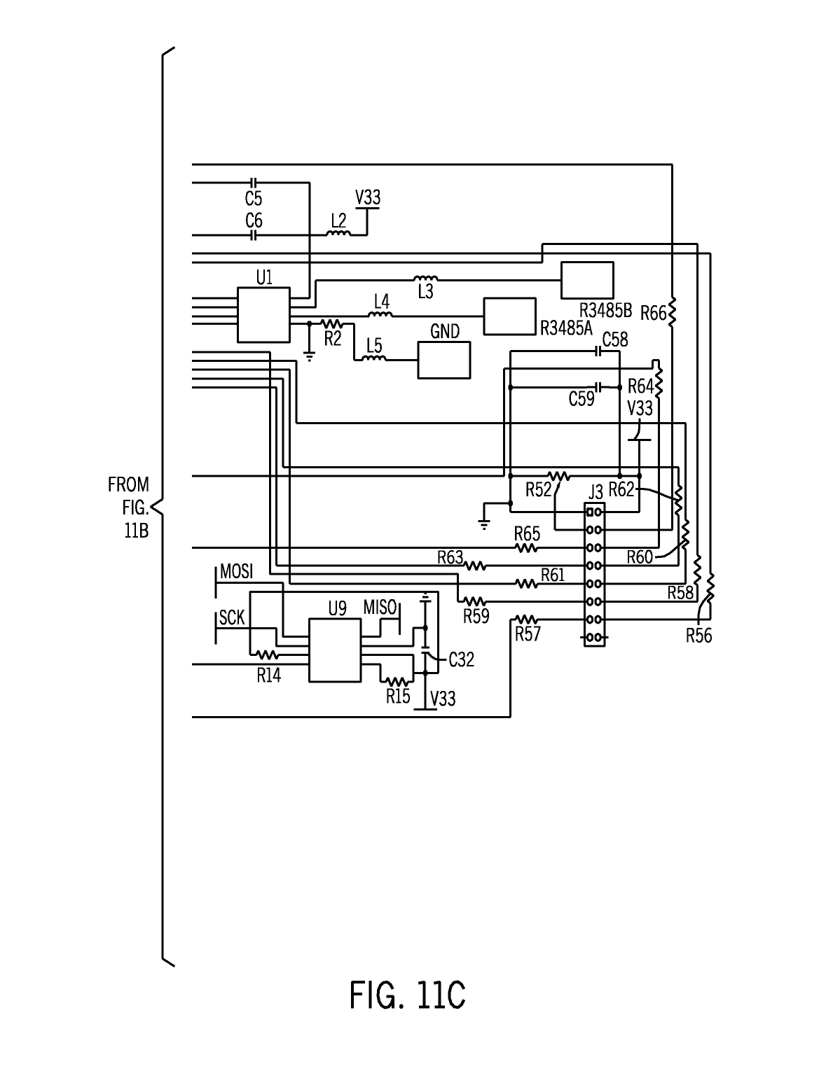

As also shown in FIGS. 8A and 8B, U15 is a header that connects to the RTD board. In the embodiment of FIGS. 8A and 8B, the RID header board may include a 1K ohm resistor connected to selected pins of U15. As shown in FIGS. 8A and 8B, this RTD is used for the reference voltage applied to U12A. As also shown in FIGS. 8A and 8B, a 100 ohm resistor may be connected between selected pins of U15. As shown in FIGS. 8A and 8B, this RTD provides the feedback from the 100 ohm RID. A second temperature sensor (U13A, U13B shown in FIGS. 8A and 8B) is located on the RID board. U12A, U12B is for one flow sensor and U13A, U13B is for a second flow sensor. As shown, this circuit can handle two flow sensors values and two temperature values. Temperatures are read through an analog to digital converter (ADC U6 in FIG. 9), then to the micro-controller (U2 shown in FIGS. 11A, 11B and 11C).

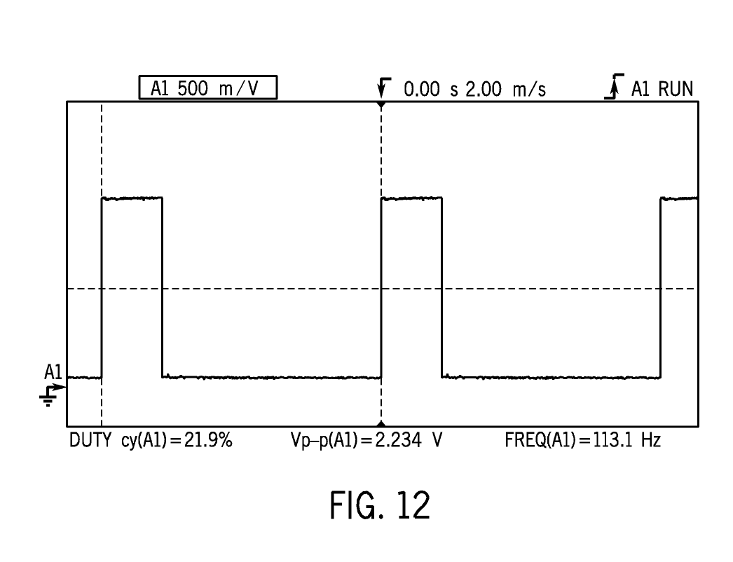

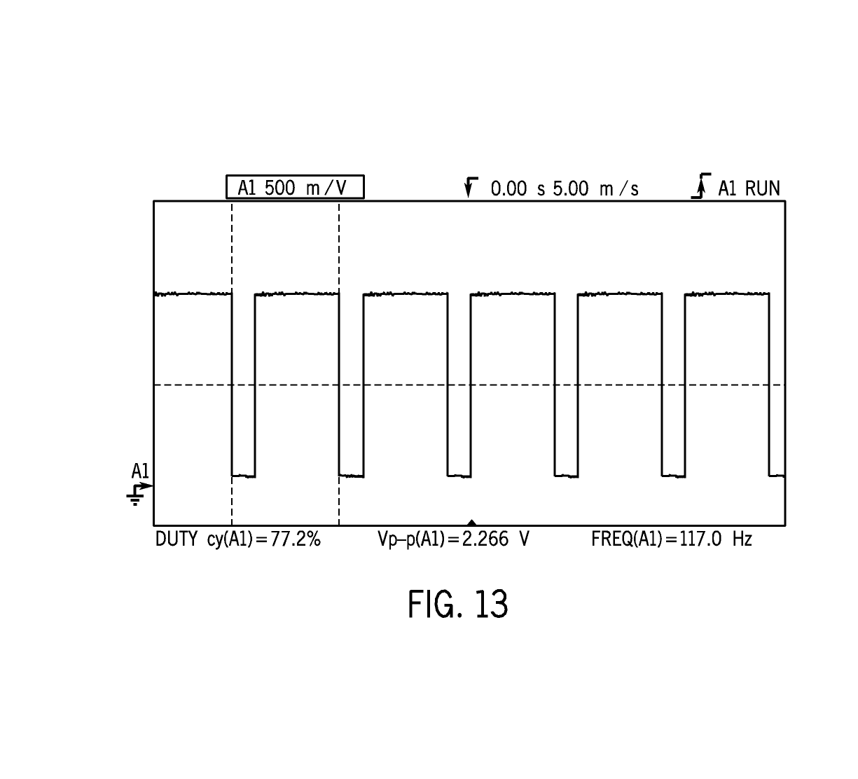

Each sensor creates a pulse waveform (see FIGS. 12 and 13) that is read into the micro-controller. These pulses are denoted as Pulse1 and Pulse2 in FIGS. 8A and 8B. The duty cycle of these waveforms correlates to the flow rate of the liquid being measured. As can be seen in FIG. 12, the duty cycle for such a pulse is approximately 21.9% with a peak to peak voltage of approximately 2.234 volts with a frequency of approximately 113.1 Hz. FIG. 13 illustrates a pulse duty cycle of approximately 77.2% with a peak to peak voltage of approximately 2.266 volts with a frequency of approximately 117.0 Hz. Again referring to FIGS. 8A and 8B, the micro-controller measures the time that the pulse is on vs. the time the pulse is off and calculates the duty cycle of the sensor. Micro-controller (U2) reads the duty cycle and temperature readings, then linearizes these values to obtain an accurate flow rate of the measured liquid.

Reference throughout this specification to “one embodiment,” “an embodiment,” “a preferred embodiment” or similar language means that a particular feature, structure, or characteristic described in connection with the embodiment is included in at least one embodiment of the present invention. Thus, appearances of the phrases “in one embodiment,” “in an embodiment,” “in a preferred embodiment,” and similar language throughout this specification may, but do not necessarily, all refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. While the present invention has been described in connection with certain exemplary or specific embodiments, it is to be understood that the invention is not limited to the disclosed embodiments, but, on the contrary, is intended to cover various modifications, alternatives, modifications and equivalent arrangements as will be apparent to those skilled in the art. Any such changes, modifications, alternatives, modifications, equivalents and the like may be made without departing from the spirit and scope of the invention.

1. A digital flow meter adapted to measure fluid flow past a surface on one side of a wall, the meter comprising:
a first reduced thickness area in said wall and a second reduced thickness area in said wall spaced from said first reduced thickness area;
a first detector comprising a first temperature sensitive element thermally coupled to said first reduced thickness area of said wall to provide thermal transfer between fluid in contact with said surface and said first detector;
a second detector comprising a second temperature sensitive clement thermally coupled to said second reduced thickness area of said wall to provide thermal transfer between fluid in contact with said surface and said second detector;
a sensor for sensing the temperature of said first and second temperature sensitive elements;
a first heating element for heating said first temperature sensitive element proximate to said first detector;
a second heating clement for heating said second temperature sensitive element proximate to said second detector;
a source for providing input power and control signals to said first and second heating elements; and
a source for transmitting output signals from said temperature sensor.

2. The digital flow meter of claim 1 wherein said first and second reduced thickness areas are thermally isolated from each other.

3. The digital flow meter of claim 1 wherein the surface of a wall includes the surface of a wall of a tube.

4. The digital flow meter of claim 3 wherein the first reduced thickness area has a first inner diameter and the second reduced thickness area has a second inner diameter, the second inner diameter being at least 10 times smaller than the first inner diameter.

5. The digital flow meter of claim 3 wherein the digital flow meter has a turndown ratio of at least 100 to 1.

6. The digital flow meter of claim 3 wherein the meter has a turndown ratio of between 100 to 1 and 1000 to 1.

7. The digital flow meter of claim 1 including:
a third reduced thickness area in said wall spaced from said first and second reduced thickness areas;
a third detector comprising a third temperature sensitive element thermally coupled to said third reduced thickness area of said wall to provide thermal transfer between fluid in contact with said surface and said third detector;
a sensor for sensing the temperature of said third temperature sensitive element;
a third heating clement for heating said third temperature sensitive element proximate to said third detector;
a source for providing input power and control signals to said third heating element.

8. The digital flow meter of claim 7 wherein said first, second and third reduced thickness areas are thermally isolated from each other.

9. The digital flow meter of claim 7 wherein the first, second and third temperature sensitive elements are each a resistance temperature detector.

10. The digital flow meter of claim 7 wherein the surface of a wall includes the surface of a wall of a tube.

11. The digital flow meter of claim 7 wherein the first reduced thickness area has a first inner diameter, the second reduced thickness area has a second diameter, and the third reduced thickness area has a third diameter, the second inner diameter being at least 10 times smaller than the first inner diameter and the third inner diameter being at least 10 time smaller than the second inner diameter.

12. The digital flow meter of claim 11 wherein the digital flow meter has a turndown ratio of at least 1000 to 1.

13. The digital flow meter of claim 11 wherein the meter has a turndown ratio of between 1000 to 1 and in excess of 2400 to 1.

14. A digital flow meter adapted to measure fluid flow, the meter comprising:
a tube having a first section having a first diameter and second section having a second diameter;
a first reduced thickness area in the tube within the first section, and a second reduced thickness area in the tube within the second section spaced from said first reduced thickness area;
a first detector comprising a first temperature sensitive element thermally coupled to said first reduced thickness area of the tube to provide thermal transfer between fluid in contact with the tube and said first detector;
a second detector comprising a second temperature sensitive element thermally coupled to said second reduced thickness area of the tube to provide thermal transfer between fluid in contact with the tube and said second detector;
a first sensor for sensing the temperature of said first and second temperature sensitive elements;
a first heating element for heating said first temperature sensitive element proximate to said first detector;
a second heating element for heating said second temperature sensitive element proximate to said second detector;
a source for providing input power and control signals to said first and second heating elements; and
a transmitting member for transmitting output signals from said first temperature sensor.

15. The digital flow meter of claim 14 including:
a third reduced thickness area within a third section of the tube having a third diameter, the third reduced thickness area being spaced from both said first and second reduced thickness areas;
a third detector comprising a third temperature sensitive element thermally coupled to said third reduced thickness area of the tube to provide thermal transfer between fluid in contact with the tube and said third detector;
a second sensor for sensing the temperature of said third temperature sensitive element;
a third heating element for heating said third temperature sensitive element proximate to said third detector;
a source for providing input power and control signals to said third heating element; and
said transmitting member transmitting output signals from said second temperature sensor.

16. The digital flow meter of claim 15 wherein said first, second and third reduced thickness areas are thermally isolated from each other.

17. The digital flow meter of claim 15 wherein the first, second and third temperature sensitive elements are each a resistance temperature detector.

18. The digital flow meter of claim 17 wherein the digital flow meter has a turndown ratio of at least 1000 to 1.

19. The digital flow meter of claim 17 wherein the meter has a turndown ratio of between 1000 to 1 and in excess 2400 to 1.

20. The digital flow meter or claim 17 wherein the meter can measure fluid flow rates from approximately 0.05 ml/min to approximately 120 ml/min.
